(19) United States
(12) Patent Application Publication
(10) Pub. No.: US 2012/0183055 A1
(43) Pub. Date: Jul. 19, 2012

(54) Temporal Prediction Structure Aware Temporal Filter

(75) Inventors: Danny Hong, New York, NY (US); Wonkap Jang, Edgewater, NJ (US); Michael Horowitz, Austin, TX (US); Stephan Wenger, Hillsborough, CA (US)

(73) Assignee: Vidyo, Inc., Dallas, TX (US)

(21) Appl. No.: 13/008,556

(22) Filed: Jan. 18, 2011

(51) Int. Cl. H04N 7/32

(52) U.S. Cl. 375/240.12; 375/E07.243

(57) ABSTRACT

Disclosed are a system, method, apparatus, and computer readable media containing instructions for pre-filtering one or more pictures of a prediction structure. In an exemplary embodiment, a system includes an input for receiving the one or more pictures and a pre-filter, operatively coupled to the input and receiving the one or more pictures. The pre-filter can include a prediction position determining module for determining a position of at least one picture in the prediction structure, a context memory for storing determined position information, and a filter module for selecting a filter context based on the determined position and using the selected filter context to filter the at least one picture.

### FIELD OF THE INVENTION

The present invention relates to the reduction of noise in a video signal before encoding, and in particular, to spatial and/or temporal filtering of a video picture.

### BACKGROUND

Temporal noise reduction is an important part of real-time, video encoding system because it enables the system to produce significantly higher quality video as compared to a system without noise reduction at the same bit rate. Temporal noise is doubly detrimental to coded video quality. First, the noise itself can be distracting after it is encoded, and later decoded and rendered. Second, temporal noise may require a (possibly large) fraction of the available bandwidth to encode the noise only (particularly at higher bit rates) thereby reducing the availability of bits to encode more perceptually relevant features.

An effective temporal noise reduction technique can significantly reduce the magnitude of noise without introducing visible artifacts (e.g., motion trailing artifacts). Temporal noise reduction techniques can leverage the zero-mean nature of the temporal noise by time-averaging the video signal. Many temporal noise filtering techniques have been proposed over time. An overview is, for example, provided in J. Brailean et. al, “Noise Reduction Filters for Dynamic Image Sequences: A Review”, Proceedings of the IEEE, Vol 83. No. 9, September 1995.

One known temporal noise reduction technique involves the adding of spatially collocated luma samples, (and, separately, chroma samples) in the current and previous picture; the resulting sum is divided by two. In this time-averaging process, the zero-mean noise is averaged to zero while the desired non-zero-mean portion of the video signal persists. Another known temporal noise reduction technique involves the calculation of a weighted averaging that may be applied to the samples. Further, it is known to apply a motion detection algorithm and apply averaging only to those samples that are determined not to be in motion (averaging of moving objects causes undesirable blurring). In this technique, the moving objects are not filtered. Also, it is known to be advantageous for high motion video sequences to motion compensate a picture prior to averaging so that moving objects can be filtered without blurring. In the techniques listed above, frame averaging is applied to frames that occur sequentially in time. For example, samples in the current frame are averaged against samples in one or more previous frames.

Video coding can use inter picture prediction to leverage the similarity between different pictures in the video signal. Different prediction structures can be used. One prediction structure is known as IPPP, and has been in use since at least the advent of ITU-T Rec. H.261 in 1988. Depending on the video coding standard, in this prediction structure, P pictures reference previous P-pictures and/or the previous I picture. Another prediction structure, in use in conjunction with MPEG-2, is known as IBBPBBPBBPBB. Here, the P pictures can refer only to previous P pictures and to the previous I picture, whereas B pictures can refer to all I and P pictures, including those located in the future.

When layered coding is involved, prediction structures can be more complex. FIG. 1 depicts a prediction structure involving a base layer (that can include, for example, of I or P pictures), and two temporal enhancement layers, that can include, for example, of P pictures. Specifically, the base layer (101) includes pictures (102), and (103), and these pictures can include references (such as motion vectors) referring to other base layer pictures only. Arrows (104) and (105) denote these references. While these arrows only point to the respective previous picture (in time), it should be noted that modern video compression standards, such as H.264, do allow pictures to reference into the future.

Arrows (104) and (105) also shows the relationship of what is called in this description a “reference picture”, and are, therefore, depicted as a solid arrow. Specifically, picture (102) is a reference picture to picture (103), as shown by solid arrow (104). In this description, the term “reference picture” is used to denote the one picture that fulfills three conditions: a) it can be referenced by the picture currently under operation (being referred from), b) it is, in the temporal domain, in the “past” of the current picture (“past” can be interpreted as in the coding order domain or as in the temporal domain, depending on application and video coding standard), and c) it is the closest picture in the time domain. If picture (103) is the current picture, then picture (102) must be the reference picture, as it fulfills all three conditions. This terminology is used here despite the fact that, even without concepts such as long-term memory, temporal enhancement layer pictures can be predicted from more than one reference picture, as discussed later.

Base layer pictures can be spaced far apart in the temporal domain. At a frame rate of 30 frames per second (fps) of the original video sequence, pictures (102) and (103) are four frame intervals or approximately 133 ms apart from each other, yielding a base layer frame rate of 7.5 fps.

The prediction structure also includes two temporal enhancement layers (106) and (112).

A first temporal enhancement layer (106) enhances, when decoded in combination with the base layer (101), the frame rate to 15 fps, by interleaving its 7.5 fps spaced apart pictures (107) and (108) with the base layer. From a video coding viewpoint, pictures of the first temporal enhancement layer (106) can have dependencies (109), (111) to base layer pictures, as well as dependencies (110) to other pictures in the first enhancement layer (106). The dependency (110) is depicted here by a dashed arrow because it is not a “reference picture” dependency in the sense as defined above. Specifically, picture (107) is not a reference picture to picture (108), because it does not fulfill condition (c) mentioned above, as picture (103) is closer to picture (108) in time distance than picture (107).

A second enhancement layer (112) is shown here to enhance, when used in combination with base layer (101) and first enhancement layer (106), the overall frame rate to 30 fps. Shown here are four pictures (113), (114), (115), (116), at 15 fps. Reference picture dependencies are shown as solid arrows, (117), (118), (119), (120). Also shown, as dashed arrows, are dependencies that are not reference picture dependencies: (121) and (122).

In processes known heretofore, pre encoding filtering and the picture structure implemented in the encoding process have been viewed as independent.

### SUMMARY OF THE INVENTION

Disclosed are a system, method, apparatus, and computer readable media containing instructions for pre-filtering one or more pictures of a prediction structure. In an exemplary embodiment, a system includes an input for receiving the one or more pictures and a pre-filter, operatively coupled to the input and receiving the one or more pictures. The pre-filter can include a prediction position determining module for determining a position of at least one picture in the prediction structure, a context memory for storing determined position information, and a filter module for selecting a filter context based on the determined position and using the selected filter context to filter the at least one picture.

The filtered video stream can be compressed in a video encoder using a standard or non-standard video compression format. The output of the video encoder can be a compressed bitstream that may be stored, packetized, transmitted, or otherwise used.

In another arrangement, a method of pre-filtering one or more pictures of a prediction structure is disclosed. An exemplary method includes determining a position of at least one picture in the prediction structure, selecting a filter context based on the determined position, and using the selected filter context to filter the at least one picture.

In another arrangement, a computer readable media having computer executable instructions included thereon for performing a method of pre-filtering one or more pictures of a prediction structure is disclosed. The above exemplary method or others can be utilized.

In some embodiments, the filter context includes filter strength and/or a filter type. The filter can be a temporal filter and/or a spatial filter. The filter context can include pixel strength information, and wherein the strength of the filter for a given pixel is adjusted based on at least one criterion.

### BRIEF DESCRIPTION OF THE DRAWINGS

FIG. 1 is a block diagram showing a prediction structure based on a layered coding using a base and two temporal enhancement layers.

FIG. 2 is a block diagram illustrating an exemplary architecture of a video encoding system including pre-filter and encoder in accordance with an embodiment of the present invention.

FIG. 3 is a block diagram showing an exemplary architecture in accordance with an embodiment of the invention.

FIG. 4 is a flow diagram showing the operation of a pre-filter in accordance with an embodiment of the invention.

While the disclosed subject matter will now be described in detail with reference to the figures, it is done so in connection with the illustrative embodiments.

### DETAILED DESCRIPTION OF THE INVENTION

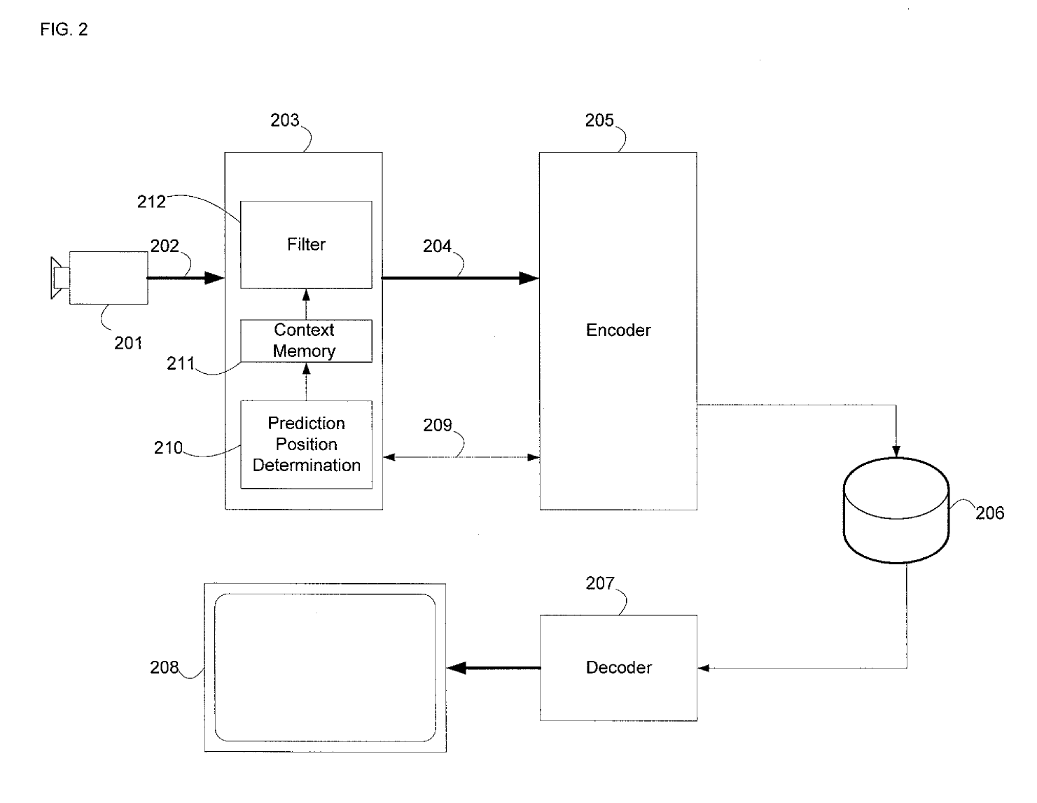

FIG. 2 shows the architecture of an exemplary video compression system according to the invention. An uncompressed video source (201), such as a camera, generates a noisy, uncompressed video stream (202), shown in the figure as a boldface arrow to denote the high bandwidth, uni-directional nature of this stream. This uncompressed video stream (202) may be in any suitable format, such as ITU-BT 601. The uncompressed video stream is filtered in video pre-filter module (henceforth pre-filter) (203). The filtered video stream (204) is compressed in a video encoder module (205), using any of the standard or non-standard video compression formats. The output of the video encoder (205) is a compressed bitstream that may be stored, packetized, transmitted, or otherwise used. Depicted in FIG. 2 is storage in a video database (206). The stored video bitstream may be read from the video database (206), and processed by a decoder (207) and rendered on a screen (208).

According to an embodiment of the invention, the pre-filter (203) adjusts at least one of its internal parameters according to the position of the picture in the prediction structure. In order to do this, it can be helpful if the pre-filter has knowledge about the position in the prediction structure of the next picture to be coded by the encoder (205). This knowledge, henceforth, is referred to as synchronization of pre-filter and encoder.

According to an embodiment of the invention, the encoder (205) can provide the pre-filter (203) with a synchronization information signal (209) that can include information about the position in the prediction structure of the next picture to be processed by the pre-filter. In this case, the synchronization may be established at any picture boundary, and there is no need to keep state in the pre-filter about the position in the prediction structure.

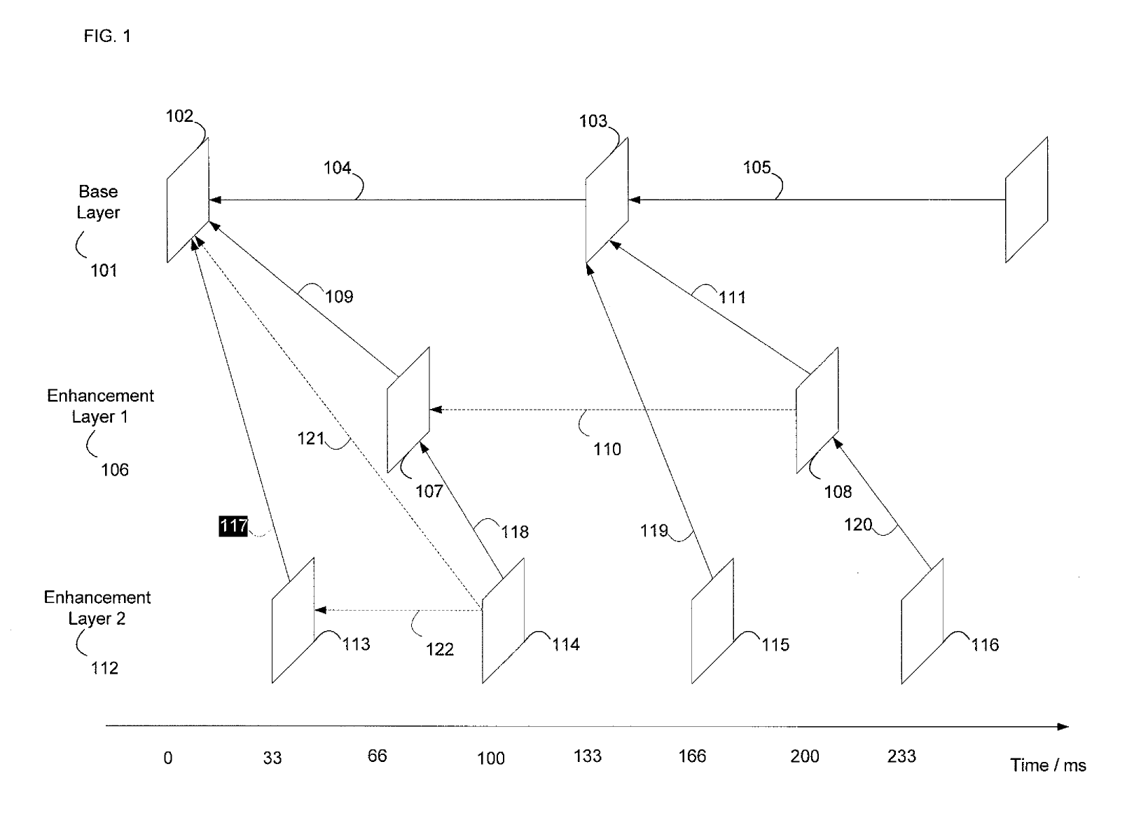

In the same or another embodiment, the pre-filter includes a prediction structure position determination module (210), which can determine the position in the prediction structure of the next picture to be processed by the pre-filter by observing the boundary between uncoded pictures and operating a state machine that determines the position in the prediction structure locally. Such a state machine can, for example, maintain a counter that counts the pictures (as identified, for example, using a vertical synchronization signal that is present in many uncompressed video formats. Each time the position in the prediction structure of a picture needs to be determined, the counter is being modulo divided by the number of pictures in the prediction structure. Briefly referring to FIG. 1, the shown therein are two instances of the same prediction structure, the first one consisting of pictures (102), (107), (113) and (114), the second consisting of pictures (103), (108), (115), and (116). Accordingly, in this example, there are four positions in the prediction structure, corresponding with the mentioned pictures (102), (107) (113) and (114) (or their corresponding pictures in the second prediction structure depicted. Position 0 corresponds to the base layer picture (102), position 1 corresponds to the second enhancement layer picture (113), position 2 corresponds to the first enhancement layer picture (107), and position 3 corresponds to the second enhancement layer picture (114).

Different prediction structures can include a different number of pictures, and, therefore a different modulo value.

In this embodiment, it has to be ensured that encoder and pre-filter have common knowledge of the prediction structure to be used. As both units use the same prediction structure information (which can, for example, be hard coded), there is no need for complex synchronization mechanisms.

In the same or another embodiment, a hybrid between local determination of the position in the prediction structure and the signaling of that position can be used. For example, it can be sensible that the signal (209) conveys information about a synchronization point, such as the position of the I picture in an IBBPBBPBB type prediction structure.

The decision between these and other possible mechanisms for synchronization depends largely on implementation practicalities. If, for example, pre-filter and encoder run on the same hardware, the overhead for a synchronization information signal (209) is negligible.

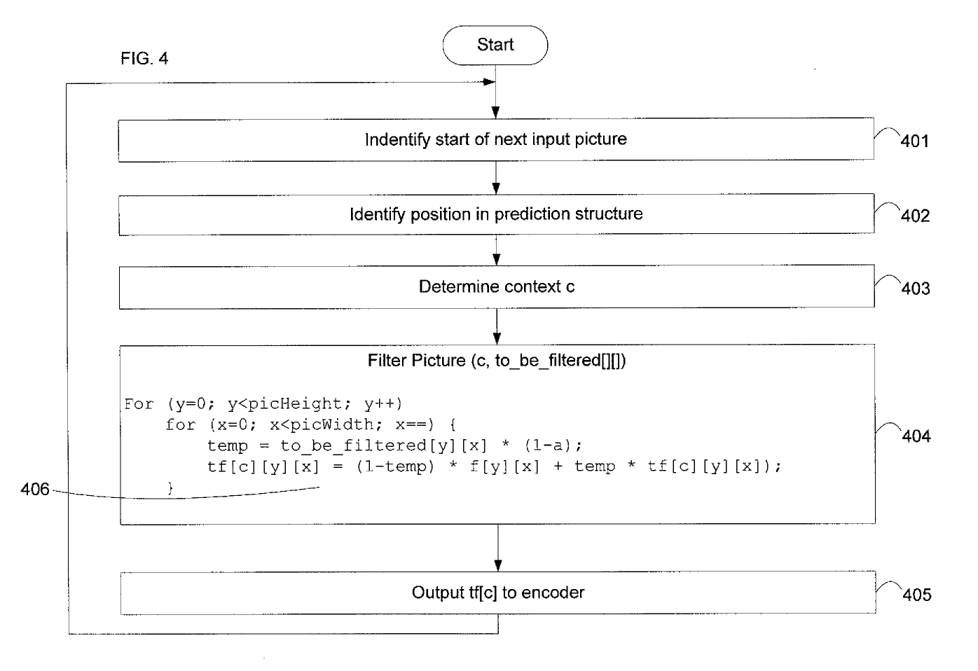

In the same or another embodiment, the pre-filter can include a context memory (211). The context memory can include more than one contexts that can be addressed based on the position in the prediction structure, as explained later when describing FIG. 4 and specifically steps 403 and 404.

In the same or another embodiment, the pre-filter can include a configurable filter (212) that can use information from the context memory (211), and filters the samples of the incoming unfiltered and uncompressed video sequence (202) to the filtered, uncompressed video sequence (204).

Pre-filter (203) and encoder (205) can be implemented in hardware, software, or any combination of hardware and software.

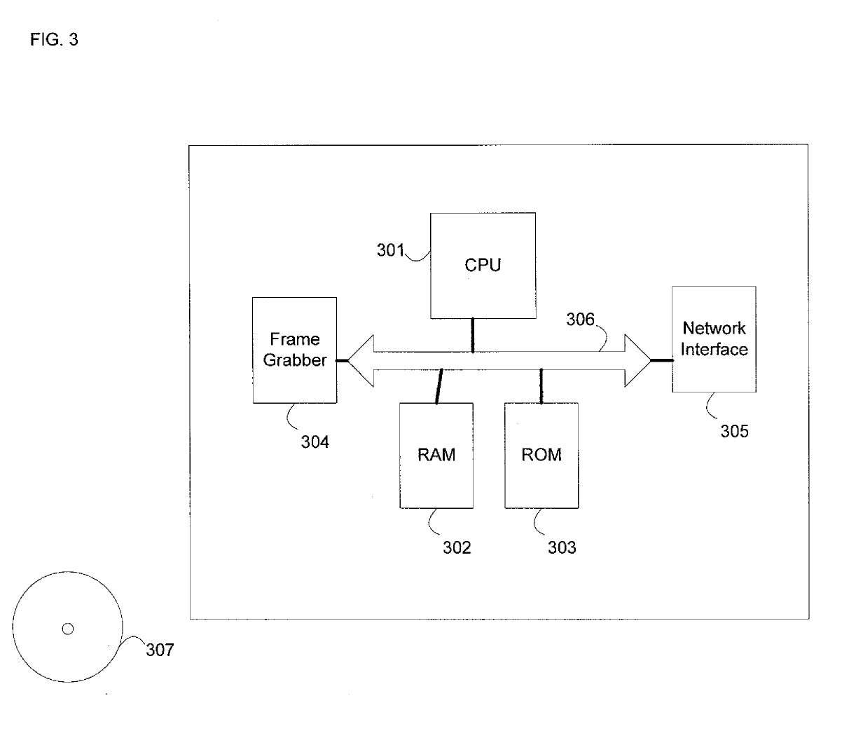

Referring to FIG. 3, in the same or another embodiment, both pre-filter and encoder operate on a system comprising general purpose CPU (301), which can be coupled to RAM (302), ROM (303), frame grabber (304) which supplies the CPU (301) or the RAM (302) with the uncompressed video, and a network interface (305) which can be used to output the compressed bitstream, all connected through a bus (306). In this case, the combination of the aforementioned devices can be in the form of a personal computer, PDA, mobile phone, digital camera, or other device. In order to operate, the system can require software implementing a method such as the one discussed below, which can be stored on a computer readable medium (307) such as ROM, Flash memory, CD, or memory stick.

FIG. 4 shows a flow chart of an exemplary operation of a pre-filter that could be used in conjunction with a system as described in FIG. 3 and above. The pre-filter can be operating on one color plane (such as the Y plane) only, according to the same or another embodiment of the invention. Other color plane can advantageously be filtered by a similar pre-filter mechanism, operating on the respective plane only.

This example uses a prediction structure like the one shown in FIG. 1, but can be extended to operate on other prediction structures as well. Other prediction structures can include more or fewer layers, more or fewer pictures in the prediction structure, and so forth. One key property of a prediction structure that makes the use of the invention beneficial is that it includes at least one picture that is used (directly or indirectly) by at least one but not all, other pictures. In the example of FIG. 1, picture (107) is used as a reference picture for picture (114), but not for any other picture. Therefore, a video sequence to be coded with the exemplary prediction structure described in FIG. 1 benefits from the use of the invention.

Returning to FIG. 4, first (401), the start (first sample) of a new uncompressed picture is identified. In a continuous operation of the filter while coding a video sequence, this step can be “empty” in the sense that the first sample of a new picture immediately follows the final sample of the previous picture; the identification of the picture boundaries can be performed using horizontal and vertical synchronization signals that can be part of the uncompressed video signal.

Then, the position in the prediction structure is determined (402). In this example, this position is identified by a layer identification: base layer, or first or second enhancement layer. The nature of this determination has already been discussed.

Briefly referring to FIG. 1, it is reiterated that pictures of the base layer (101) and the first enhancement layer (106); that is, pictures (102), (103), (107) and (108), only use the pictures (102), (103) of the first enhancement layer (101) as a reference (104), (105), (109), (111). In contrast, pictures of the second enhancement layer (112) can use, as a reference pictures of either the base layer or the first enhancement layer. For example, the reference (117) for picture (113) point to base layer picture (102), whereas the reference (118) for picture (114) point to first enhancement layer picture (107).

The nature of the exemplary filter of the embodiment is that it creates an exponentially weighted moving average over all previous reference pictures of the picture to be coded. From the previous description it is evident that there are two weighted averages, one calculated over base layer pictures only (that is used to filter the base and first enhancement layer pictures), the other calculated over base and first enhancement layer pictures (that is used to filter the second enhancement layer pictures). The exponentially weighted average is part of a “context”. Accordingly, there are two contexts.

Returning to FIG. 4, depending on the picture's position in the prediction structure, a context can be selected (403) as follows. For base layer pictures, and for first enhancement layer pictures, a first context is selected. In contrast, for pictures of the second enhancement layer, a second context is selected.

A context can contain the aforementioned exponentially weighted moving average, and can also contain other information as discussed later.

Next, a filter is applied (404) that takes as its input the context as determined in (403). The filter of the example calculates an exponentially weighted moving average over time, for corresponding samples. More precisely, for all pixels of f and tf[c] respectively, tf[c]=a*f+(1−a)*tf(c) where tf(c) is the temporally filtered picture of context c and f is the input frame. It should be noted that tf[c] is being overwritten during the execution of this instruction with the new, filtered image, that is also the output (405) of the filter process. The strength of the filter, a, can be any value between 0 and 1. One exemplary value for video conferencing style content, consumer electronic quality cameras, and 30 fps operation of the second enhancement layer can be 7/16, or 0.4375.

In the example, all pixels of a picture are filtered. In some scenarios, for example at lower frame rates or high motion, it is sensible to avoid filtering moving content, so not to incur motion blur. In other examples, parts of the picture, for example in a “picture-in-picture’ application, deliberately show noise whereas other parts of the picture are supposed to be noise-free. Therefore, in the same or another embodiment, the filtering of a given sample can be conditioned on one or more criteria such as the presence of motion, large changes in the picture content (such as scene cuts in only parts of the picture), deliberate insertion of motion into parts of the picture, and so on. Such a condition can, for example, be implemented by populating a two-dimensional field of filter strength values “to_be_filtered[ ][ ]” with values of 0 or 1. For an x and y, the value of the spatially corresponding pixel after filtering is multiplied with to_be_filtered [y][x] (406). The use of non-boolean filter strength values gives the option to gradually reduce the noise filtering based on the strength of the criteria determined. For example, if it has been detected that motion is present, it may be sensible to gradually reduce the noise filter strength to balance out the annoying artifacts resulting from motion blur and camera noise.

In the same or another embodiment, the filter strength can be selected differently by context. In this case, advantageously, the filter strength is part of the context.

A distinguishing factor between this exemplary filter according to the invention and other, prior art temporal pre-filters is the need for multiple (here: two) filtered references for the three layers involved.

Different filter scenarios can be utilized. For example, one context can be maintained for all pictures in a given layer, and prediction relationships other than what is described here as a reference picture can be exploited.

The example shows an IIR filter with a single coefficient. In the same or another embodiment, the context can contain other filter types with different number of coefficients, whose application may require the storage of additional filtered or unfiltered pictures in the context.

Even more complex are motion compensated filters that motion-compensate the reference picture(s) (that is: the pictures used in the filter which are not the current input picture) against the to be pre-filtered input picture, before applying the filter. In this case, the context may include the motion vectors found during the previous motion search, with heuristic search algorithms that assume linear motion utilized. For example, a motion search mechanism, in order to avoid unnecessary complexity, can perform a diamond search around to centers: a (0, 0) motion vector (i.e. assuming no motion), or the centered around the previous motion vector found for this sample. If the movement in the scene has not changed or changed only by small amounts in direction or speed, the latter search is likely to quickly converge to a new motion vector, whereas the former search can require many operations, especially when the motion is fast and the motion vector, therefore, long. The article Wiegand, T.; Xiaozheng Zhang; Girod, B., “Long-term memory motion-compensated prediction”, IEEE CSVT, Vol 9, Issue 1, February 1999, pp. 70-84, contains more examples on efficient motion search using context memories similar to the ones described herein, and is incorporated by reference herein.

For some applications, like the coding of entertainment video (TV shows) it may be helpful to include scene cut detection. If a scene cut were detected, advantageously, a new prediction structure is started, and, accordingly, the pre-filter uses this restarted prediction structure. It can be advantageous to implement the scene cut detection in the pre-filter. Briefly referring to FIG. 2, in this case, the detected scene cut can be communicated from pre-filter (203) to encoder (205), over the, in this case, bi-directional communication link (209).

The example above included a hard criterion of the use of the position of a picture in a prediction structure, namely that filtering occurs only against reference pictures. However, the invention also envisions a “soft” use of the position in the prediction structure. For example, in some scenarios it can be sensible to include information from pictures elsewhere in the prediction structure, but with a reduced filter weight.

In addition, not included in the example but equally sensible can be to perform spatial filtering in the pre-filter. The nature of the spatial filter (i.e. filter type or coefficients) can also advantageously be adapted based on the position of the picture to be filtered in the prediction structure.

It will be understood that in accordance with the disclosed subject matter, the techniques described herein can be implemented using any suitable combination of hardware and software. The software (i.e., instructions) for implementing and operating the aforementioned layout management techniques can be provided on computer-readable media, which can include, without limitation, firmware, memory, storage devices, microcontrollers, microprocessors, integrated circuits, ASICs, on-line downloadable media, and other available media.

We claim:

1. A method of pre-filtering one or more pictures of a prediction structure, comprising
a) determine a position of at least one picture in the prediction structure;
b) selecting a filter context based on the determined position; and
c) using the selected filter context to filter the at least one picture.

2. The method of claim 1, wherein the filter context includes a filtered picture.

3. The method of claim 1, wherein the filter context includes a filter strength.

4. The method of claim 1, wherein the filter context includes a filter type.

5. The method of claim 1, wherein the filter includes a temporal filter.

6. The method of claim 1, wherein the filter includes a spatial filter.

7. The method of claim 1, wherein the filter context includes pixel strength information, and wherein the strength of the filter for a given pixel is adjusted based on at least one criterion.

8. A system for pre-filtering one or more pictures of a prediction structure, comprising
a) an input for receiving the one or more pictures
b) a pre-filter, operatively coupled to the input and receiving the one or more pictures therefrom, comprising
a prediction position determining module for determining a position of at least one picture in the prediction structure,
a context memory, operatively coupled to the prediction position determining module, for storing determined position information, and
a filter module, operatively coupled to the context memory, for selecting a filter context based on the determined position and using the selected filter context to filter the at least one picture.

9. The system of claim 8, wherein the filter module is adapted to filter using a filtered picture.

10. The system of claim 8, wherein the filter module is adapted to filter using a filter strength.

11. The system of claim 8, wherein the filter module is adapted to filter using a temporal filter.

12. The system of claim 8, wherein the filter module is adapted to filter using a spatial filter.

13. The system of claim 8, wherein the filter module is adapted to filter pixel strength information, and wherein the strength of the filter for a given pixel is adjusted based on at least one criterion.

14. The system of claim 8, further comprising a video encoder, operatively coupled to the pre-filter and receiving the at least one filtered picture therefrom, for encoding the at least one filtered picture.

15. A computer readable media having computer executable instructions included thereon for performing a method of pre-filtering one or more pictures of a prediction structure, comprising
a) determine a position of at least one picture in the prediction structure;
b) selecting a filter context based on the determined position; and
c) using the selected filter context to filter the at least one picture.

16. The media of claim 15, wherein the filter context includes a filtered picture.

17. The media of claim 15, wherein the filter context includes a filter strength.

18. The media of claim 15, wherein the filter context includes a filter type.

19. The media of claim 15, wherein the filter includes a temporal filter.

20. The media of claim 15, wherein the filter includes a spatial filter.

21. The media of claim 15, wherein the filter context includes pixel strength information, and wherein the strength of the filter for a given pixel is adjusted based on at least one criterion.
